(19) United States
(12) Patent Application Publication
(10) Pub. No.: US 2026/0284929 A1
(43) Pub. Date: Sep. 24, 2026

(54) PRESS MOULDING METHOD OF A FIBER PRODUCT AND A FIBER PRODUCT

(71) Applicant: Blue Ocean Closures AB, KARLSTAD (SE)

(72) Inventor: Lars Sandberg, Hammarö (SE)

(73) Assignee: Blue Ocean Closures AB, Karlstad (SE)

(21) Appl. No.: 19/472,382

(22) PCT Filed: Apr. 16, 2024
(86) PCT No.: PCT/EP2024/060306

§ 371 Date: Oct. 3, 2025

(30) Foreign Application Priority Data
Apr. 17, 2023 (SE) 2350452-5

(51) Int. Cl. B27N 3/04; B27N 3/20; B31B 50/59; B31B 120/10; B31D 5/02; B32B 5/02

(52) U.S. Cl. CPC B27N 3/04; B27N 3/20; B32B 5/02; B31B 50/592; B31B 2120/10; B31D 5/02; B32B 2307/7376

(57) ABSTRACT

A press moulding method produces a shaped press moulded fiber product, at high pressure and high temperature, by means of a press pad device and a stamp device. The press pad device includes an open space having a bottom part and a wall part and the stamp device has a mating form that provides a product gap in relation to the press pad device, where the fiber product is produced from a sheet like blank having an integrated fibre network that is cut out from a sheet of raw material with an integrated fibre network and formed in the gap. The blank after press moulding will be shaped into the fiber product by providing the blank with at least one excess portion and that the at least one excess portion before pressing or in connection with pressing is pushed into a neighboring portion of the blank to be integrated in at least one reinforcing portion of the fiber product.

### TECHNICAL FIELD

This invention relates to a press moulding method of a fiber product, at high pressure and high temperature from a sheet like blank consisting of an integrated fibre network, by means of a press pad device and a stamp device, for performing the method.

### TECHNICAL BACKGROUND

A fiber product can be made by pressing different kind raw materials, e.g. wood flakes as is known from U.S. Pat. No. 4,248,820 and WO 2009132318. However, this invention relates to a different field where a web or a sheet of fibers consisting of an integrated fibre network is used. Typically, a combination of natural fibers (e.g. wood pulp fibers), synthetic fibers (e.g. polyolefin-based fibers such as those made of e.g. polyethylene) and other additives such as binder or dye is used. In many applications it is preferred that such a web essentially merely comprises of natural fiber, with or without additives. Typical process conditions are 150-250° C. and pressures 100-10000 bar (200-2000 Bar). Moisture content may typically be less than 20%, as is disclosed in e.g. WO 2018013397 and U.S. Pat. No. 4,227,710.

The fiber product can be in the form of a hollow product, for example a package or a closure (lid, screw cap or similar), but can also be a flat product. Products can be formed from a web of the material and punched/cut in connection with forming, e.g. that have been completely or partially separated from the web to allow deeper shaping. This exposure is typically done by cutting the material into a shape that is adapted to the final shape. Typically, for example, a roundel is cut to form a round package.

The press moulding typically takes place with two tools where both the outer tool pad and the inner tool (stamp) can consist of several parts to enable discharge of the finished product. Typically, the pad opens while the stamp collapses. The piston, parts of the piston or parts of the pad can also be made of a compressible material which enables greater vertical compressive forces, typically against the sides of the cavity, by the tool material being reshaped during the compression.

Further examples of known methods described above are shown in EP 3,736,099 and WO 2020/165780.

### SUMMARY OF THE INVENTION

It is an object of the invention to optimize from a strength perspective for some applications regarding shaped press moulded fiber products, as defined in the independent claims.

Thanks to the invention reinforced shaped press moulded fiber products may be achieved with a low need of raw material in a cost efficient manner. It is a specific advantage that in contrast to folded reinforcing parts of a fiber product the invention will produce reinforcing parts wherein the fibre network is integrated in favorable manner, thanks to the principle of using a pushing action to form the reinforcing parts, i.e. providing an optimized fibre network prior to pressing and/or during pressing.

### DESCRIPTION OF FIGURES

In the following, the invention will be described with reference to a preferred embodiment of a flat shaped press moulded fiber products in which:

FIG. 1 shows a perspective view of a shaped press moulded fiber product for use as a bottle holder, according to the invention,

FIG. 2 shows a cross-sectional view along A-A in FIG. 1.

FIG. 3 shows a view from above of a shaped press moulded lid, according to the invention

FIG. 4 shows a cross-sectional view along B-V in FIG. 3,

FIG. 5 shows a view from above of a preferred pre-cut raw material intended for production of a lid as shown in FIGS. 3 and 4, according to the invention, and

FIG. 6 schematically shows a cross-sectional view of a mould for production of a lid as shown in FIGS. 3 and 4, according to the invention.

### DETAILED DESCRIPTION

As understood by the skilled person the invention is based on use of a fiber press mould (not shown), comprising a press pad device and a stamp device, for forming a fiber product according to the invention. The stamp device may be solid in one piece or divisible into two or more pieces. Said device, may further be collapsible. The press pad device comprises a body arranged with at least one cavity, which body 20 may be solid or divisible into two or more pieces. The stamp member comprises a body adapted to fit into the cavity such that a gap may be formed between the side surface thereof and the sidewalls of the cavity, whereby a desired thickness of side walls may be achieved and further shaped in manner to achieve also flat and/or curved parts of a desired thickness of a fiber product by pressing to a distance achieving the desired thickness

The material in the fiber product 1 comprises natural fibers such as natural fibers from wood, straw, such as bagasse, and/or recycled wood fibers or a combination thereof, preferably natural wood fibers, most preferred virgin natural wood fibers, or when sustainability is of importance re-cycled wood fibers may be preferred. Preferably the raw material is a sheet having an evenly distributed amount of fibres in each cross-sectional part thereof and also a basically constant thickness, whereby all parts have substantially the same density, wherein blanks are cut out from said sheet for pressing in subsequent step. The amount of water in a pre-cut blank (e.g. roundel) prior to pressing shall preferably not exceed 20% the weight of fiber. The moulding temperature may be in the range of 150-250° C. and the applied pressure by the stamp 3 and additional stamp device 4, is at least 200 bar. The pressure may further be applied so that it is from about 500 to about 1000 bar.

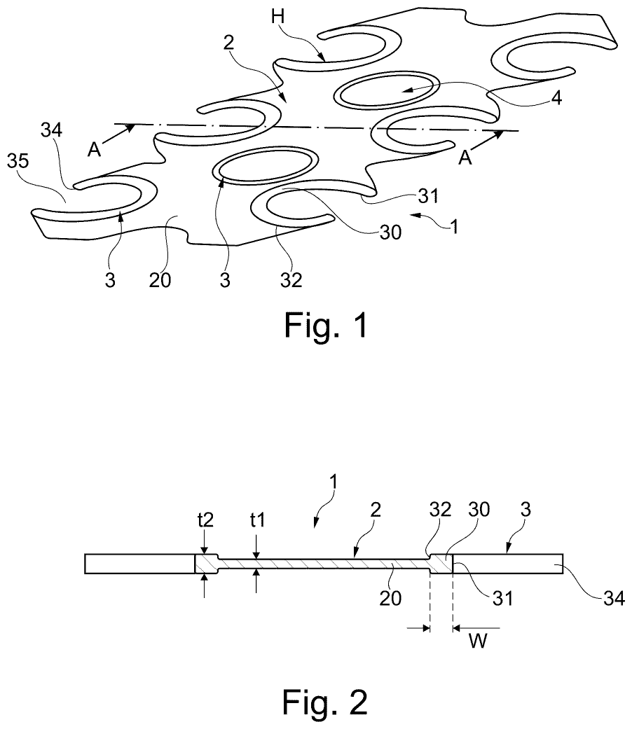

In FIG. 1 there is shown an exemplary embodiment of a product produced in accordance with the invention. There is shown a bottle holder 1 having a plurality of passages 35 forming holder members H for holding bottlenecks and two holes 4 for carrying the bottle holder 1.

The bottle holder has a support part 2 made of cellulose fibres in accordance with the dry forming process described above. The bottle holder 1 comprises reinforcing members 3 that assist in providing enhanced strength properties at selected areas. The selected areas may be positioned in various positions depending on the product. The basic principle for achieving these reinforcing members reside in providing more fibres into the areas that form reinforcing members 3. This may be achieved by reallocating fibres of raw material and providing for transfer of fibres into selected desired areas.

Accordingly, in the shown exemplary embodiment this may be achieved by moving fibre material away from the areas that in a final product will form passages 35, 4 by moving those fibres transversally within the fibre layer that will result in a higher amount of fibres in the crosswise direction in those desired areas forming reinforcing members 3. This may for instance be achieved by having protruding, penetrating parts in accordance with the form that the passage shall have in a final product, for instance circular for the holes 4 and a portion of a circle for the bottle holders H. As a result, the reinforcing members 3 may be made to have a thicker reinforcing body 30 than the body 20 of the support part 2 achieving outer edges 32 as transition zones and possibly more rounded inner edges 31. Preferably the semi-closed passages 35 will be arranged with compressed pheripheral edges 34, that may provide extra strength and/or wear ability.

In FIG. 2 it is shown that a cross-sectional view along line A-A in FIG. 1 and hence it is shown that the support body 20 will have a thickness tl that is smaller than the thickness t2 within the reinforcing body 30 of the reinforcing members 3. As can be noted the width W of the reinforcing body 30 will then be limited. The width W may be used to control the density as well as also the thickness t2 of the reinforcing body 30. In the shown embodiment all fibres that are present in the area of the passages H, 4 of the blank before pressing, for the bottle holder 1 will be pushed away into neighbouring areas and there being integrated to form reinforcing members 3 having a reinforcing body 30 with more fibres and greater thickness t2. As a result of pushing the fibres from the passages there will be achieved a higher strength in the reinforced areas 3. By controlling the size of the pressing members (not shown) the thickness t2 and also the width W of the reinforcing members 3 may be controlled. Hence if smaller thickness t2 is chosen the density will increase even more. Accordingly, even if the density within the support body 20 and the reinforcing body 30 of the reinforcing members 3 have the same density or not the strength will be higher in the reinforcing members 3 thanks to the increased amount of fibres. The actual amount of fibres may be determined by using microscopic pictures and (e.g. computer aided) analysis of cross-sectional cuts through a product wherein the amount of fibres within a certain distant of the cut surface, e.g. the whole width W of the reinforcing members 30 is compared with the amount of fibres within the same cut surface an equal distance (i.e. W) of the neighbouring body 20. As is evident the same functionality will be achieved also in connection with the holes 4 for carrying the bottle holder 1. Hence reinforcing members 3 will be achieved around the holes 4, which will increase strength and which may also provide better comfort for carrying the bottle holder 1. In a more preferred embodiment the reinforcing members 3 have curved parts, e.g. being semi-circular or circular.

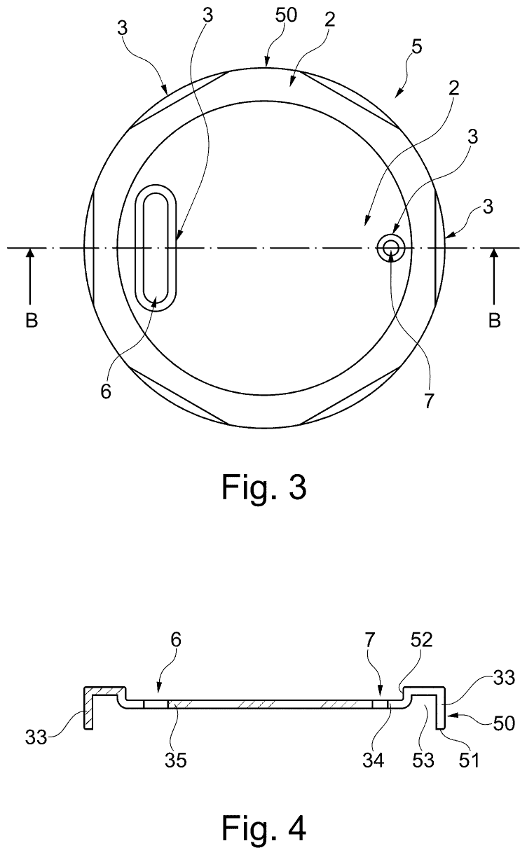

In FIGS. 3 and 4 there is shown an alternative exemplary embodiment in accordance with the invention. Here it is shown in the form of a lid 5 to be used for a cup. The lid 5 is arranged with a passage 6 adapted for drinking from and a hole 7 for allowing air to enter into the cup when drinking. In a known manner the lid 5 is arranged with a collar 50 having a U-shaped form that may be used to snap onto the upper edge of a cup.

In FIG. 4 it is shown a cross-sectional view of the lid 5 along lines B-B. It can be noted that the cross-sectional line passes through a plurality of reinforcing members 3. There are reinforcing members 3 within an outer collar part 50, which reinforcement bodies 33 have the same thickness as the other parts of the lid but having larger amount of fibres pressed into that volume. Hence, that body part 33 has a higher density than the majority of the body parts of the support part 2 of the lid. In the same manner it is shown that there is arranged a compressed body part 34 of higher density around the cut hole 7 and also a corresponding compressed body part 35 around the drinking passage 6.

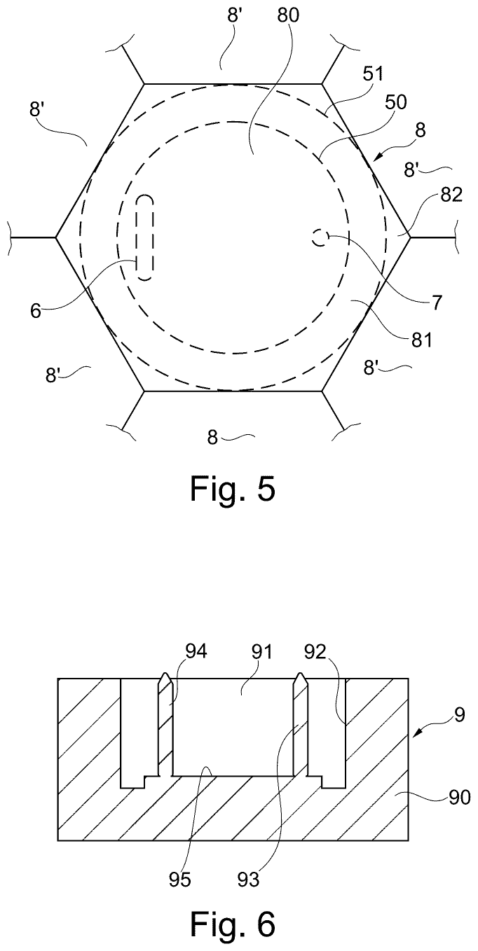

In FIG. 5 there is shown a preferable kind of pre-cut blank 8 that may be used to produce lids 5 in accordance with that shown in FIGS. 3 and 4. As is noted the shape of the present raw material 8 is polygonal, preferably hexagonal, which preferably are cut out from a wide sheet of raw material providing space for a plurality of pre-cut start raw material pieces 8,8′ in a neighbouring manner, without any spillage. Preferably the raw material for the pre-cut blank 8 is a sheet having an evenly distributed amount of fibres in each cross-sectional part thereof and also a basically constant thickness, whereby all parts have substantially the same density. There is also shown with markings 51 the part that will form the lower edge 51 of the lid in the final products as well as also a circle 50 that marks the part where the outer upper part of the collar 50 of the lid will be shaped. Moreover, it is shown indications marking where the drinking passage 6 and the air hole 7 will be positioned in the final product.

In FIG. 6 there is schematically shown an exemplary female part of a mould that may be used to produce the lid 5 in accordance with the invention. As can be noted the form is arranged with a first protruding part 94 adapted to the desired form of the drinking passage 6 (e.g. oval) and also a second protruding part 33 adapted to the form (e.g. circular) of the air hole 7.

Moreover, it can be noted that the outer periphery 92 of the mould has a diameter that corresponds to the circle line 50 of the pre-cut raw material 8.

When producing the lid 5 as shown in FIG. 5 there will be cut out from the larger sheet of raw material a pre-cut blank 8, e.g. a plurality of hexagonal parts, each being used to produce one lid 5. It is understood that thanks to using hexagonal shape the yield of the basic sheet may be much higher than if circular raw materials are being used since they may be stamped out without any waste in-between as indicated by showing the plurality of neighbouring raw materials 8′. It is evident that the same principle may be used for pre-cut blanks being rectangular.

Once the sheet raw material 8 has been cut out it will be moved down into the mould 9 and thereby the protruding parts 94, 93 will penetrate through the raw material and push fibres transversally into neighbouring areas. When moved further down the edge portions 81, 82 of the raw material 8 will be folded upwards and positioned along the inner wall 92 of the mould 9. And now when the stamp is pressed from above down into the mould 9 the uppermost edge parts 82 will first be pushed/pressed into the lower part 81 of the collar area and thereby the corner portions 82 of the raw material 8 will be pushed into the cylindrically formed lower part 81 of the raw material and be integrated into the part that will form the outer collar wall 50. As a consequence, there will be a higher amount of fibres within the parts that have integrated therein the corner portions 82, to form reinforcing members 3. In the same manner the fibres that have been pushed away by the protruding parts 94, 93 will arrange for providing reinforcing members 3 with more fibres around these passages 6, 7. By using a stamp (not shown) that provides for unified thickness of the lid as show in FIG. 4 the density of the reinforcing members 3 will be higher than the rest of the support body 2 of the lid 5, i.e. having greater strength thanks to higher density.

As understood the reinforcing members 3 may be achieved in different manners. However, there will crosswise always be a higher amount of fibres in the reinforcing members than in the main part of the support body 20.

It is evident for the skilled person that combinations of the above mentioned, exemplary embodiments may be used and that by using and adjusting measures of the mould the different properties may be achieved to adapt the reinforcing member 3 to desired property within different parts within one and the same product. However always having the member integrated into the other.

1. Press moulding method of a shaped press moulded fiber product, at high pressure and high temperature, by means of a press pad device and a stamp device, said press pad device including an open space having a bottom part and a wall part-said stamp device having a mating form providing a product gap in relation to said press pad device wherein said fiber product is produced from a sheet like blank comprising an integrated fibre network that is cut out from a sheet of raw material consisting of comprising an integrated fibre network and formed in said gap and whereby said blank after press moulding will be shaped into said fiber product, characterized by providing said blank with at least one excess portion and that said at least one excess portion before pressing or in connection with pressing is pushed into a neighboring portion of said blank to be integrated in at least one reinforcing portion of said fiber product.

2. Press moulding method according to claim 1, wherein after pressing said reinforcing portion is integrated with a support body having a thickness that is smaller than the thickness of a reinforcing body of the reinforcing members

3. Press moulding method according to claim 1, wherein said at least one excess portion before pressing is pushed into a neighboring portion of said blank by means of at least one protruding device arranged within said press pad device, thereby forming at least one passage having a reinforcing body at the edge of said passage.

4. Press moulding method according to claim 1, wherein said at least one excess portion in connection with pressing is pushed into a neighboring portion of said blank by means of pushing a corner part of a polygonal blank into an edge zone of said fiber product.

5. Press moulding method according to claim 1, wherein the material comprises natural fibers such as natural fibers from wood, straw, such as bagasse, and/or recycled fiber or a combination thereof.

6. Press moulding method according to claim 1, wherein the moulding temperature is 150-250° C. and the pressure on said bottom part is at least 200 bar.

7. Press moulding method according to claim 1, wherein the amount of water in said sheet like blank does not exceed the amount of fiber, wherein preferably the weight of water in the material does not exceed 20% the weight of fiber.

8. Press moulding method according to claim 1, wherein said pre-cut blank is cut out from a sheet having an evenly distributed amount of fibres in each cross-sectional part thereof that is to be used and also a basically constant thickness, whereby all parts that is to be used have substantially the same density.

9. A shaped press moulded fiber product obtained from an integrated fibre network by the method according to claim 1, comprising a support body and at least one reinforcing member integrated with said support body, said reinforcing member having a reinforcing body that includes more fibers than the body of the support body, said shaped press moulded fiber product comprising an passage enclosed by said reinforcing member

10. A shaped press moulded fiber product according to claim 9, wherein said reinforcing body forms a semi-closed passage providing a rim arranged to support an object.

11. A shaped press moulded fiber product according to claim 9, wherein the thickness of said reinforcing body is larger than the thickness of said body.

12. A shaped press moulded object-supporting fiber product according to claim 11, wherein said thicknesses are in the range of 1 ,1t1<t2<3t1.

13. A shaped press moulded object-supporting fiber product according to any of claims 9-12, wherein the width of said reinforcing body is larger than the thickness of said reinforcing body.

14. A shaped press moulded object-supporting fiber product according to claim 13, wherein the range of the width of said reinforcing body is 1,1t2<W<3t2.
